(19) United States
(12) Patent Application Publication
(10) Pub. No.: US 2025/0010281 A1
(43) Pub. Date: Jan. 9, 2025

(54) METHOD AND DEVICE FOR PRODUCING A SUBSTRATE FOR AN EXHAUST GAS AFTERTREATMENT DEVICE

(71) Applicant: UMICORE AG & CO. KG, Hanau-Wolfgang (DE)

(72) Inventors: Karlheinz RUCKDAESCHEL, Schallbach (DE); Karoline KOZUBSKI, Rheinfelden (DE); Melanie WASSMER, Rheinfelden (DE)

(73) Assignee: UMICORE AG & CO. KG, Hanau-Wolfgang (DE)

(21) Appl. No.: 18/479,207

(22) Filed: Oct. 2, 2023

(30) Foreign Application Priority Data
Jul. 3, 2023 (DE) 102023117464.9

(51) Int. Cl. B01J 37/02; B01D 53/94; B01J 35/04; B01J 37/08; F01N 3/28

(52) U.S. Cl. CPC B01J 37/0215; B01D 53/94; B01J 35/56; B01J 37/0236; B01J 37/08; F01N 3/2803; B01D 2258/01; F01N 2370/02

(57) ABSTRACT

The invention relates to a method for producing a substrate (1) for an exhaust gas aftertreatment device having the following steps:
1. Applying (S1) a coating material (12) on an elastic base (11) that is mounted over a flexible cushion (21);
2. Dipping or pressing (S2) a surface of the substrate (1), in which inlet openings of through-channels (2) through the substrate (1) are arranged, into the coating material (12);
3. Lifting the coated catalyst element (1); and
4. Aftertreating, and in particular drying or calcining (S3), the coating material (12) on the coated substrate (1).

### TECHNICAL FIELD

The invention relates to a method for producing substrates for exhaust gas aftertreatment devices as catalyst elements or filter elements for internal combustion engines, and in particular measures for preventing the occurrence of clogging/blocking phenomena, also known as face plugging, at a fluid flow inlet of the catalyst element.

### TECHNICAL BACKGROUND

Exhaust gas aftertreatment devices—in particular, in the form of catalytic converters, i.e., catalytically-coated flow substrates or filters, e.g., wall flow filters—are generally used for the purification of combustion exhaust gases—for example, from internal combustion engines. These enable the chemical conversion of undesired components of the combustion exhaust gas, such as carbon monoxide, nitrogen oxides, unburnt hydrocarbons, soot, and the like, or a filtering of combustion exhaust gas. As a rule, exhaust gas aftertreatment devices of this kind have one or more substrate bodies. A substrate body generally comprises a plurality of through-channels. The through-channels extend completely through the substrate body or, in the case of a wall flow filter, mostly through the substrate body, so that a filter is formed by the porous substrate material between adjacent filter channels. The inner walls of the through-channels may be coated with a catalyst material to form a catalytic surface on which corresponding reactions and/or absorptions can take place to eliminate the undesired exhaust gas components.

The through-channels are generally parallel in the substrate and are separated from one another by walls of the substrate material—in particular, a ceramic material. The through-channels generally have inlet openings which are arranged on a face of the substrate. This leads to the fact that the face on which the inlet openings of the through-channels are arranged has a plurality of webs on which components of the exhaust gas, such as particles, aerosols, droplets, and the like, can be deposited during the operation of the exhaust gas aftertreatment element and can form a down of contamination. This process is known as clogging, blocking, or sooting, and is generally referred to as face plugging. Face plugging occurs in particular in operating states in which the exhaust gas contains many soot particles or aerosols.

The exhaust gas back-pressure in the exhaust gas aftertreatment device is increased by face plugging, which can impair the efficiency of the internal combustion engine. If the face plug is not removed, a system failure can also occur.

One option for preventing face plugging is to provide the face of a substrate with a precious-metal-containing coating, which has enhanced catalytic properties. Such a measure is known, for example, from the document EP 2171232 B1. From this, a device for the aftertreatment of engine exhaust gases is known which has a substrate that has a cellular structure defining fluid passages that are designed to enable fluid flow through the substrate, wherein the substrate has an inlet end surface that is positioned at one end of the substrate, wherein the substrate is coated with a chemical coating. The chemical coating on the inlet end surface has an increased load relative to any other chemical coating on the substrate in order to prevent and/or eliminate a surface entry blockage on the substrate, wherein the inlet end surface comprises a three-dimensional topographical configuration so that the substrate is non-planar at the inlet end, and the chemical coating is arranged on the three-dimensional topographical design.

Due to the production process of such substrates for exhaust gas aftertreatment devices, apart from the inlet openings of the through-channels, the face on which the inlet openings of the through-channels are arranged is not flat, but can have an irregular, concave, or convex design. This makes it difficult to apply a face coating, which is supposed to be provided—in particular, uniformly—on all web-like structures between the through-channels.

In this regard, document EP 3195348 B1 provides a system for depositing a surface coating on a monolithic catalytic substrate. The system comprises a coating liquid applicator which is arranged between an inflow and discharge system, wherein the coating liquid applicator has an inner core and an outer nub with a height, a coating liquid trough positioned below the coating liquid applicator, to receive the full length of the coating liquid applicator within the coating liquid trough and to retain a coating liquid. The coating liquid trough is positioned vertically such that the nub of the coating liquid applicator is at least partially immersed in the coating liquid. With a motor, the coating liquid applicator is driven at a certain predetermined rotational speed during operation, wherein operation is controlled depending upon a sensor signal from a light sensor. During operation, a substrate coating liquid is applied to the coating liquid applicator, a monolithic catalytic substrate is moved through the coating liquid applicator at the predetermined speed so that an amount of the coating liquid is transferred from the coating liquid applicator to a surface of the monolithic catalytic substrate, wherein, depending upon a detection of whether a light beam is blocked by the coating liquid applicator, the height of the coating liquid applicator is set at an adjusted height.

Furthermore, the document EP 3400108 B1 discloses a method for coating a terminal surface of a substrate with a liquid, which comprises a catalyst component, wherein a substrate is conveyed to a coating roller, and the liquid is applied to a terminal surface of the substrate by bringing the terminal surface into contact with the coating roller, which is loaded with the liquid. Conveying the substrate to the coating roller comprises bringing the terminal surface of the substrate into contact with a rotating surface of the coating roller. In this case, the terminal surface is brought into contact with the rotating surface of the coating roller.

The above prior art has the disadvantage that it does not allow a reproducible, uniform coating with non-planar faces of the substrate. The penetration depth of the coating material into the through-channels also cannot be adjusted by the known manufacturing processes.

It is an object of the present invention to provide a method for coating a face surface of a substrate, which has inlet openings of through-channels, with a coating material that reduces face-plugging, which enables uniform coating even in the case of non-planar faces of the substrate, and enables a reproducible layer thickness and penetration depth into the through-channels.

### DISCLOSURE OF THE INVENTION

This object is achieved by the method for producing a substrate for an exhaust gas aftertreatment device according to claim 1 and a corresponding device and a substrate according to the independent claims.

Further embodiments are specified in the dependent claims.

According to a first aspect, a method for producing a substrate (1) for an exhaust gas aftertreatment device has the following steps:
applying (S1) a coating material (12) on an elastic base (11);
dipping or pressing (S2) a surface of the substrate (1), in which inlet openings of through-channels (2) through the substrate (1) are arranged, into the coating material (12);
lifting (S3) the coated substrate (1); and
aftertreating, and in particular drying or calcining, the coating material (12) on the coated substrate (1),
wherein the elastic base (11) extends over a flexible cushion (21), and said cushion absorbs the pressure of the substrate (1) on the elastic base (11) such that all the inlet openings of through-channels (2) through the substrate (1) can be wet with the coating material (12).

The method according to the invention is advantageously used to prevent face plugging and enable a uniform coating even with non-planar faces of the substrate with a reproducible layer thickness and penetration depth of the coating material into the through-channels. In this case, the coating material is preferably applied to the face of the substrate in a separate production step, independent of the actual catalytic coating of the substrate. The face corresponds to one side of the substrate in which openings, and in particular the inlet openings, of the through-channels end in the substrate. The coating is generally carried out with a precious-metal-containing material. The substrate produced in this way can be advantageously used in an exhaust gas aftertreatment device which has one or more substrates.

Suitable substrates are the embodiments known to a person skilled in the art in the automotive exhaust field. The through-channels can penetrate the substrate completely—so-called flow-through substrates—or in the case of a wall flow filter, can extend to such an extent into the substrate that the porous substrate material represents a filter for the exhaust gas between parallel-running, adjacent through-channels. Substrates which have been catalytically coated with a catalyst material are also called catalyst elements.

Flow-through substrates are conventional catalyst elements in the prior art, which can consist of metal or fiberglass-reinforced paper (corrugated carrier, e.g., WO17153239A1, WO16057285A1, WO15121910A1, and the literature cited therein), or ceramic materials. Refractory ceramics, such as cordierite, silicon carbide or aluminum titanate, etc., are preferably used. The number of channels per area is characterized by the cell density, which typically ranges between 300 and 900 cells per square inch (cpsi). The wall thickness of the channel walls in ceramics is between 0.5-0.05 mm.

All ceramic materials customary in the prior art can be used as wall-flow filters. Porous wall-flow filter substrates made of cordierite, silicon carbide, or aluminum titanate are preferably used. These wall-flow filter substrates have inflow and outflow channels, wherein the respective downstream ends of the inflow channels and the upstream ends of the outflow channels are alternately closed off with gas-tight “plugs.” The exhaust gas that is to be purified and that flows through the filter substrate is thereby forced to pass through the porous wall between the inflow channel and outflow channel, which delivers an excellent particulate filtering effect. The filtration property for particulates can be designed by means of the porosity, pore/radii distribution, and thickness of the wall. The porosity of the wall-flow filters is generally more than 40%, generally from 40% to 75%, and particularly from 45% to 70% [as measured in accordance with DIN 66133, latest version on the filing date]. The average pore size (diameter) is at least 3 μm—for example, from 3 μm to 34 μm, preferably more than 5 μm, and in particular from 5 μm to 28 μm, or from 7 μm to 22 μm [measured according to DIN 66134, latest version on the date of application].

The surfaces in the through-channels of the substrate can be coated with a catalyst material. The process step of coating the through-channels with a catalyst material is optional and can take place before, during, or after the process step of face coating according to the invention with the coating material. Between these process steps, drying, reduction, and calcination steps can take place.

The coating material (12) can comprise a catalytically-active component, and in particular a precious-metal-containing solution. The coating material can be identical to the catalyst material, different therefrom, or can have a modified concentration of catalytically-active components. The coating material can be produced, for example, on the basis of precious-metal-containing solutions or suspensions with an adsorbent or non-adsorbent property; in particular, Rh-, Pt-, and Pd-containing precious metal solutions or suspensions should be mentioned here. Such coating materials then have catalysts for the oxidation of hydrocarbons into H₂O and CO₂, CO into CO₂, or can also help reduce NOx.

The catalytic function of the coating material is therefore essentially provided by the metals Rh, Pt, and/or Pd, and preferably Pt and/or Pd or Rh, or Rh and Pd, which may be a thickened solution or, in an alternative embodiment, may be supported on high-surface-area carrier oxides.

For a person skilled in the art, suitable carrier oxides for these catalytically-active metals are high-surface-area, temperature-stable oxides. As a rule, these are aluminum oxides, silicon oxides, zirconium oxides, or titanium oxides, or mixtures thereof. Active aluminum oxide in particular is known to a person skilled in the art in this context. It particularly describes γ-aluminum oxide with a surface of 100 to 200 m²/g. Active aluminum oxide is frequently described in the literature and is commercially available. It generally contains silicon oxide or lanthanum oxide as a stabilizer in an amount of up to 10 wt % relative to the aluminum oxide.

In an alternative yet preferred embodiment, the catalytic function is provided by Rh, and/or Pd, and/or Pt which are supported on a mixture of high-surface-area aluminum oxide and common oxygen storage materials such as cerium oxides, cerium-zirconium mixed oxides, or with La, Y, Pr, Nd-doped cerium or cerium-zirconium mixed oxides.

The oxygen storage materials are preferably those in which cerium/zirconium/rare earth metal mixed oxides are found. Lanthanum oxide, yttrium oxide, praseodymium oxide, neodymium oxide, samarium oxide, and mixtures of one or more of these metal oxides may, for example, be considered the rare-earth metal oxide. Lanthanum oxide, yttrium oxide, neodymium oxide, and mixtures of one or more of these metal oxides are preferred. Particularly preferred are lanthanum oxide and yttrium oxide, and a mixture of lanthanum oxide and yttrium oxide is quite particularly preferred in this context. In a very preferred embodiment, the coating material in the final catalyst element has an oxidative function—particularly with respect to hydrocarbons, CO, and soot. In this case, in addition to the aforementioned carrier oxides, Pt and/or Pd are predominantly or exclusively present in the coating material as the catalytically-active species.

However, the above-mentioned precious metals for coating with the coating material can also be present as a possibly thickened, low-viscosity solution.

In this context, precious metal solutions are those which have the precious metals dissolved in a solvent—preferably water. A person skilled in the art knows which solutions can be used in this case. Precious metal compounds for producing the solution are in particular the following:

The palladium compound is selected from tetraamine palladium(II) chloride, palladium hydroxide, palladium chloride, palladium sulfate, palladium nitrate, diammine dinitritopalladium(II) chloride, diammine dinitritopalladium(II) sulfate, palladium glycinate, tetraamine palladium(II) sulfate, bis(ethylenediamino)palladium(II) carbonate, bis(ethylenediamino)palladium(II) sulfate, bis(acetylacetonato)palladium(II), diamine dichloropalladium(II), palladium oxide hydrate, tetraamine palladium(II) hydrogen carbonate, bis(ethylenediamino)palladium(II) chloride, and palladium acetate.

The rhodium compounds are selected from rhodium(III) chloride, rhodium(III) iodide, rhodium(III) oxide hydrate, rhodium(III) nitrate, and rhodium(III) sulfate.

The platinum compound is selected from platinum(II) chloride, tetrachloroplatinum(II) acid H₂(PtCl₄), dinitrosulfatoplatinum(II) acid and salts thereof, diamminodinitritoplatinum(II), tetraammineplatinum(II) salts, platinum(II) nitrate, hexachloroplatinum(IV) acid H₂(PtCl₆), hexahydroxoplatinum(IV) acid, tetraammineplatinum(II) acetate, tetraethylammonium hexahydroxyplatinate(IV), bis(ethanolammonium) hexahydroxyplatinate(IV), and salts thereof.

To adjust the viscosity of the coating materials, appropriate auxiliaries such as thickeners, surface-active substances, acids or bases, or shear-thinning substances can be added. A person skilled in the art knows how to proceed here (see, for example, EP3131660B1). For example, auxiliary materials such as methyl cellulose can be added to the solution for thickening.

In addition, for the construction of catalyst elements produced according to the invention, the substrates can be coated with different catalyst materials and therefore form different catalyst technologies. There may be multiple components installed in an exhaust system in the form of substrates with one or different catalytic or pollutant-adsorbing catalyst technologies. The end-face coating according to the invention can be applied to any component in which the occurrence of face plugging is expected. The application and the mode of operation of the end-face coating is independent of the component function or catalyst technology. The catalyst technologies can, for example, but not exclusively, be DOC catalysts, NSC catalysts, DPF catalysts, 3-way catalysts (TWC), SCR catalysts, ASC catalysts, or combinations of the technologies.

Diverse catalyst materials are known from the prior art, e.g., zeolites with Cu, Fe, V, W, Ce, Sb, Nb, Zr, Mo, Al, Pd can be used for SCR catalysts, as for example known from WO 2008/132452 A2, WO 2019/096785 A1, WO 2019/096786 A1, WO 2022/058404 A1, WO 2020/043662 A1, WO 2015/075083 A1, WO 2019/072527 A1, WO 2019/072527 A1, WO 2019/219629 A1, WO 2020/039074 A1, WO 2018/189177 A1, WO 2017/134001 A1, WO 2017/134005 A1, WO 2017/134006 A1, WO 2017/134007 A1, WO 2013/159825 A1, WO 2017/178576 A1, WO 2018/054928 A1, WO 2018/029330 A1, and WO 2022/128523 A1. Catalyst materials used for TWC catalysts are known, for example, from WO2022223688A1, WO2021151876A1, WO2021140326A1, WO2008000449A2, WO2008113445A1, and WO2008113457A1. The person skilled in the art is aware of which one he would use for the present purpose (see also, for example, WO2019121994A1, WO2019121995A1, WO9535152A1, WO2008000449A2, EP0885650A2, EP1046423A2, EP1726359A1, EP1541220A1, EP1900416B1, EP3045226A1, WO2009012348A1, and EP1974809B1).

Three-way catalysts consist essentially of the components: precious metal, high-surface-area carrier oxide, and oxygen-storing material. They for the most part contain platinum group metals, such as Pt, Pd, and Rh, as catalytically-active components, wherein Pd and Rh are particularly preferred. The catalytically-active metals are often deposited so as to be highly dispersed on the high-surface-area oxides and the oxygen storage materials. It is particularly preferred for the precious metals to be pre-fixed on the oxygen storage material before it is mixed with the other components into the coating mixture. With the TWC's, a zoned or layered embodiment is now the normal case. In a preferred embodiment, at least one TWC in the exhaust system having the catalyst element modified according to the invention has a 2-layer structure with two different three-way coatings—preferably as described in EP3247493A1.

The oxygen storage materials are in particular those in which cerium/zirconium/rare earth metal mixed oxides occur. Lanthanum oxide, yttrium oxide, praseodymium oxide, neodymium oxide, samarium oxide, and mixtures of one or more of these metal oxides may, for example, be considered the rare-earth metal oxide. Lanthanum oxide, yttrium oxide, neodymium oxide, and mixtures of one or more of these metal oxides are preferred. Particularly preferred are lanthanum oxide and yttrium oxide, and a mixture of lanthanum oxide and yttrium oxide is quite particularly preferred in this context.

As the carrier oxide for catalytically-active metals, for a person skilled in the art, preferably high-surface-area, temperature-stable oxides are suitable. As a rule, these are aluminum oxides, silicon oxides, zirconium oxides, or titanium oxides, or mixtures thereof. Active aluminum oxide in particular is known to a person skilled in the art in this context. It particularly describes γ-aluminum oxide with a surface of 100 to 200 m²/g. Active aluminum oxide is frequently described in the literature and is commercially available. It generally contains silicon oxide or lanthanum oxide as a stabilizer in an amount of up to 10 wt % relative to the aluminum oxide.

According to the invention, the face is to be coated with the coating material in such a way that only the face surfaces of the webs between the through-channels are coated, and the inner surfaces of the through-channels are wetted, for example, only up to a maximum depth of 0 to 20 mm, preferably between 0 and 5 mm, and particularly preferably between 0 and 2 mm, with the coating material.

As a result of production, the faces of a substrate to be coated according to the invention are frequently not planar, but can have a convex or concave structure or a structure which is irregularly shaped in some other way with respect to its axial direction. This 3-D structure of the faces can also vary within a batch of substrates.

For uniform coating with the coating material, the above method provides for the face of the catalyst element to be pressed into a coating material that is applied flat on an elastic base, wherein the flexible cushion is located under the elastic base. The coating material is provided in liquid form as a dispersion, suspension, solution, gel, or the like, which can be provided with the above-mentioned catalytically-active materials.

It can be provided that the liquid coating material be applied flat on the in particular horizontally-aligned elastic base, and in particular with a constant layer thickness.

Subsequently, the face of the substrate to be coated is pressed into the elastic base. The elastic base yields when the face of the substrate is pressed in, and the flexible cushion attached underneath provides a corresponding counterpressure of the elastic base on the face of the substrate, so that the coating material on the elastic base comes into contact with the face over the entire surface, and the coating material is thereby applied to the inner surfaces of the through-channels with a constant layer thickness and constant penetration depth, despite unevenness in the face of the substrate.

The base is formed elastically with a closed surface in order to enable an elasticity of shape when the face of the substrate is pressed on. The closed surface of the base prevents the penetration of the coating material into the material of the elastic base and below, and thereby ensures a minimization of the material loss of coating material and the longer usability of the elastic base.

The elastic base can be an elastic plastic or a rubber material, and in particular a foam rubber material and a smooth and/or closed surface. This base is to be selected such that there is, for example, an elongation of 1% with an application of force of 5-25 N/cm, and preferably 6-15 N/cm (ISO 2118), or a rigidity of 50 to 200 kp/cm of material width (Shore A hardness according to DIN 53505 of 60-95, and preferably 70-90). The base can consist, for example, of polyester with a coating made of PVC, PU, or nitrile.

In particular, a material such as, for example, a foam rubber material with a closed surface can contact the base. For example, neoprene, foam rubber, and silicone, sylomer (“Werkstoffeigenschaften und Schwingungsisolation Technische Informationen,” RRG INDUSTRIETECHNIK GMBH, www.rrg.de) and the like can be used. The elastic property of the foam rubber material can be described, for example, with a Shore A hardness (according to DIN 53505) of between 10 and 18, and in particular 12-14, and/or a density between 0.1 g/cm³ to 1 g/cm³.

In the case of substrates with extreme unevenness on the face, however, it is very advantageous according to the invention if a function exists under the elastic base which generates an appropriate counter-pressure to the elastic base as soon as the substrate is pressed onto the elastic base. According to the invention, a flexible cushion acts here as such a unit generating a counter-pressure. In this case, the flexible cushion is advantageously located in a recess of a unit which is harder, but not elastic, relative to the flexible cushion and the elastic base—preferably a base plate which cannot itself slip from the substrate being pressed in. This helps to adequately stabilize the flexible cushion against slippage.

The flexible cushion is characterized by a flexible upper side facing the underside of the elastic base. The flexible cushion consists, for example, of an optional sheath and a filling. The sheath and filling can consist of the same material. For example, a simple foam pad or silicone cushion can be used. The flexible cushion is preferably selected from a plastic material such as a silicone mat and the like. Particularly preferably, a silicone mat with a thickness of up to 10 mm, and preferably 2 mm, with a Shore A hardness (according to DIN 53505) of 60±5 is used. The person skilled in the art is aware of other alternatives.

In order to secure the flexible cushion against slipping, the flexible cushion rests preferably in a recess which has been incorporated into a correspondingly-dimensioned, fixed, and non-elastic unit—for example, a base plate. Preferably, the flexible cushion can also be formed by a recess in a base plate, which is covered by a flexible, water-tight, and air-tight material—for example, like the above-described casing. This produces a cavity between the base plate and the cover, which is referred to here as a flexible cushion. The fixation must be designed in such a way that the leakage of the filling from the cushion is prevented. A person skilled in the art is familiar with the design procedures.

The filling of the flexible cushion is preferably a gas such as air, or a liquid such as water or silicone oil, or a gel such as a water mixture thickened with thickener. For example, agar agar, guar gum, natrosol, and methylcellulose can be used as the thickener. Particular preference is given to using a stabilized water mixture. To stabilize the preferably used water, it is possible to use, for example, an addition of glycerol, silicone oil, or similar oils. A person skilled in the art is familiar with the possibilities for stabilizing the water against, for example, fungal formation.

The flexible cushion or the base plate having the flexible cushion is then positioned under the elastic base in such a way that, when the substrate is pressed into the elastic base, the flexible cushion can exert the counter-pressure over the elastic base necessary for pressing the coating material into the substrate. The base plate, if present, must therefore be designed and positioned according to the person skilled in the art.

Accordingly, the base plate preferably has a recess for or forms the flexible cushion. The recess also preferably corresponds to the dimensions of the substrate to be pressed in. The recess should be designed such that a coating material which is on the elastic base is pressed on and into the substrate as soon as the substrate is pressed into the elastic bases and the flexible cushion. In order to stabilize the recess, it can be advantageous if the recess is enclosed by a fastening ring. This promotes the stiffening of the edge of the recess, which facilitates the fixation of the flexible cushion in the recess. A corresponding flexible cushion in a recess of a base plate is shown in FIG. 5 as a plan view and in FIG. 6 with the associated elastic base as a side view. Furthermore, it can be advantageous if the recess has an access through the base plate, via which the cushion can be connected to an inlet for the filling material of the cushion. Thus, the amount of filler material in the flexible cushion can be adapted to the specifications of new substrates or coating materials quickly from the outside, without having to insert a new cushion.

The shape of the flexible cushion is adapted to the substrate, which is to be coated with the coating material. A person skilled in the art knows how to proceed here. The diameter of the recess should correspond to the shape of the substrates to be coated and be at least the same size as the employed substrate sizes or greater, and preferably 10-30 mm greater than the substrate diameter. The depth of the recess is preferably 2-15, and more preferably 2-5 mm.

In principle, the elasticity or deformability of the elastic base and the flexible cushion can be selected so that the unevenness of the face of the substrate when pressed into the base causes the base to lie against the entire surface of the face, and the coating material is therefore applied to the entire face. Macroscopic unevenness of any shape of the face-side surface can be compensated for by the interaction of elasticity of the base and the force acting upon the substrate or the catalyst element.

The entire system consisting of the elastic base and flexible cushion accordingly exerts an elasticity adapted to the substrates to be coated. The elasticity can thereby be controlled particularly advantageously by the fill-level of the flexible cushion. This elasticity can be selected, for example, so that, with a macroscopic unevenness of the face surface of, for example, +/−3 mm, and preferably +/−1.5 mm, and a contact pressure of the substrate on the elastic base and the flexible cushion of, for example, between 5 and 150 N, the pressed-on surface of the substrate rests upon the full surface in order to achieve uniform application of the coating material on all areas of the face surface. The maximum contact force should be limited only by the mechanical stability of the substrate.

Thus, the material of the elastic base and of the flexible cushion can be selected with respect to its elasticity or deformability such that, in the case of a substrate with a certain unevenness of the face, it allows the surface of the base to rest upon the entire face surface. The unit for receiving the flexible cushion in the recess is not elastic. Compared to the elastic base and the flexible cushion, it has a much higher rigidity, so that the pressure from the substrate on the elastic base and the flexible cushion do not cause any deformation of this unit.

The face of the substrate is accordingly pressed onto the elastic base to apply the coating material, as a result of which the coating material is applied to the face surfaces of the substrate, and wherein the flexibility of the elastic base plus the flexible cushion makes it possible to adapt to unevenness on the face of the substrate. For this purpose, it is advantageous if the liquid coating material is applied to the entire surface of the elastic base, and in particular with a constant layer thickness. The layer thickness of the coating material applied to the elastic base is preferably 0.2 to 4 mm, preferably 0.2 to 2 mm, and particularly preferably 0.2 to 1 mm.

In order to simplify a full surface application of the coating material to the elastic base with constant layer thickness, the coating material is preferably formed with an increased or suitable viscosity, —in particular, by using substances for adjusting the viscosity—for example, gelling agents such as polysaccharoses, celluloses, and the like. The viscosity is also selected in connection with the surface properties of the base such that contraction or droplet formation or island formation due to the surface tension of the coating material is avoided. A person skilled in the art knows how to proceed here.

Furthermore, the coating material should have shear-thinning properties, so that application of the coating material does not lead to film breaks or the like. For example, a viscosity of 0.5 to 10 Pa*s, and in particular 1 to 6 Pa*s, can be suitable here, with a shear rate of between 12 and 20 1/s, and in particular between 14 and 17 1/s, or 16 1/s (Anton Paar Rheolab QC with CC39, at 20° C., according to DIN 53019). The shear thinning allows the required uniform distribution of the material in a stable film.

The application of a quantity of coating material on the elastic base before the pressing-in process and the distribution on a surface in which the face of the substrate can be accommodated can preferably be accomplished by a doctor blade. Alternatively, the coating material can also be applied to the surface of the elastic base, prior to the pressing-in process, with the aid of a film applicator. Furthermore, the coating material can be applied to the elastic base, which is moved relative to the slot die, before the pressing-in process, with the aid of a slot die. The moved elastic base can preferably be constituted by a conveyor belt. This allows the elastic base to continue to move over the flexible cushion. Coating material can therefore be applied to the moving elastic base, and then the substrate can be pressed over the flexible cushion into the coating material on the conveyor belt (FIG. 6). Excess coating material can preferably be removed from the moving elastic base in the form of a conveyor belt, and can be supplied for reuse. Likewise, it is possible and preferred that the residual coating material of a previous coating operation remaining before the application of the coating material be removed—in particular, by scraping.

The zone length of the coating material in the substrate can then be determined via the viscosity of the coating material, the layer thickness applied to the elastic base, the contact duration, and the pressing-in pressure of the substrate. The zone length coated in this way can preferably be 0 to 20 mm, more preferably between 0 and 5 mm, and particularly preferably between 0 and 2 mm. These coating forms offer the possibility of a very precisely adjustable layer thickness of the coating material on the elastic base, with in particular a consistency of less than ±0.5 mm to ±0.1 mm, and particularly preferably up to ±0.05 mm or even ±0.03 mm, and therefore, particularly in connection with the closed surface, a reproducible and defined coating material transfer to the substrate or catalyst element.

After the face is lifted out of the coating material, the substrate can be thermally treated for drying or calcining.

According to a further aspect, a device (10) for producing a substrate (1) for an exhaust gas aftertreatment device is presented, comprising:
an in particular horizontally-oriented elastic base (11) with a closed surface;
an application unit (13) which is configured to apply a liquid coating material (12) to the base (11);
a pressing-in unit (16) which is designed to dip or press a substrate (1) to be coated into the coating material (12) after the coating material (12) has been applied, wherein the elastic base (11) extends over a flexible cushion (21), and this cushion absorbs the pressure of the substrate (1) on the elastic base (11) in such a way that all the inlet openings of through-channels (2) through the substrate (1) can be wet with the coating material (12).

In a preferred embodiment, the device is characterized in that a non-elastically-deformable base plate is arranged under the elastic base and the cushion. A further preferred embodiment is one in which the base plate has a recess into which the flexible cushion is enclosed to prevent slippage. Most preferably, the base plate provides a laterally-arranged access for filling the flexible cushion with filler material (e.g., air or water or gel).

According to a further aspect, a substrate is provided according to one of the above methods.

### SHORT DESCRIPTION OF THE DRAWINGS

Embodiments are explained in more detail below with reference to the accompanying drawings. The following are shown:

FIG. 1 a perspectival view of a face of a substrate for an exhaust gas aftertreatment device;

FIG. 2 a cross-sectional view through a substrate, to illustrate an uneven face;

FIG. 3 a schematic diagram of a device without a flexible cushion for applying a coating to a face of a substrate;

FIG. 4 a schematic diagram of a flowchart to illustrate the method for producing a substrate with a face coating without the use of a flexible cushion;

FIG. 5 a plan view of a base plate with a recess and fastening ring in which a flexible cushion is located;

FIG. 6 an arrangement according to the invention of an elastic base in the form of a conveyor belt with a flexible cushion in a recess of a corresponding base plate.

### DESCRIPTION OF EMBODIMENTS

FIG. 1 shows a perspectival view of a substrate 1 as used in conventional exhaust gas aftertreatment devices such as a catalyst element.

FIG. 2 shows a cross-sectional view through the substrate 1.

The substrate 1 is preferably formed from a porous and in particular ceramic substrate material. The substrate 1 preferably has through-channels 2 running parallel to one another, the inner walls 3 of which are optionally coated with a catalyst material in a manner known per se. The through-channels 2 can have a round, hexagonal, or square cross-section, or a cross-section shaped in some other way. The through-channels 2 end at a face 4 of the substrate 1 so that the face 4 of the substrate 1 has inlet openings 5 for the through-channels 2.

As shown in the sectional view through the substrate in FIG. 2, the face, apart from the inlet openings of the through-channels (i.e., over the entire extension of the face), is not flat, but can be deformed in the axial direction and can have a concave and/or convex and/or otherwise uneven structure. The through-channels 2 are separated from one another in the substrate material of the substrate 1 by intermediate walls 6 which, on the face, lead to web-like structures between the inlet openings 5 of the through-channels 2.

In the following, a device and a method are described by means of which a coating can be applied to the face of the substrate 1, which serves to avoid face plugging. Suitable materials for such a coating are a precious-metal-containing solution, which can differ with respect to composition and materials from the layer material, which is applied to the inner walls of the through-channels before or after the coating of the faces.

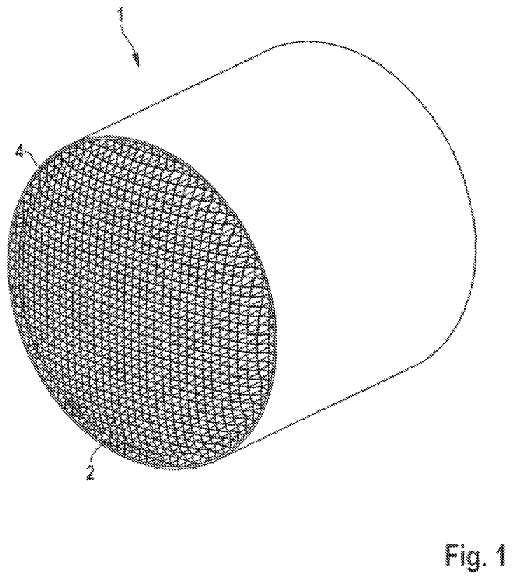

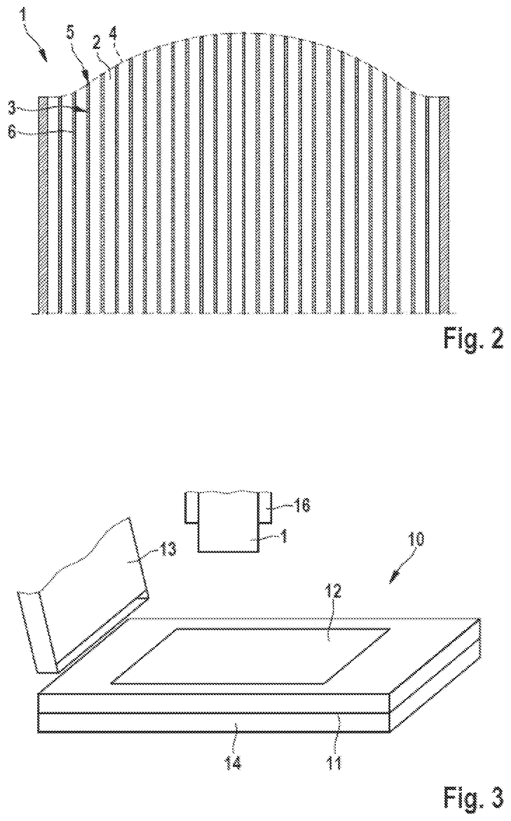

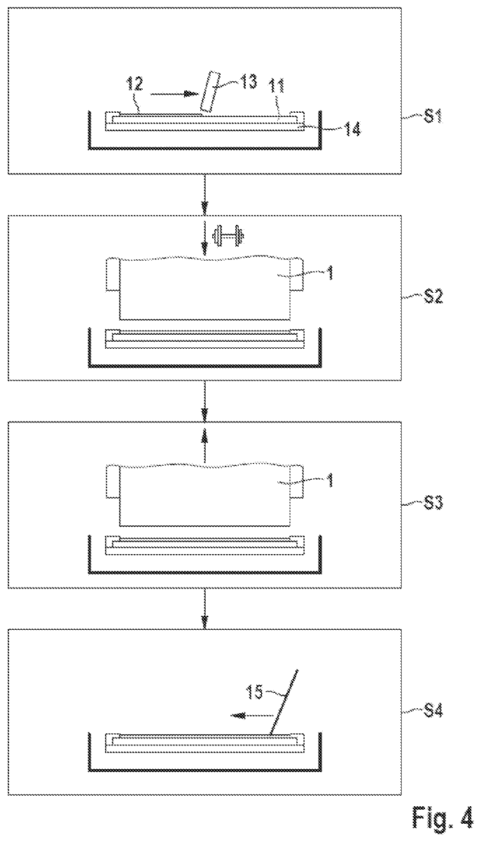

FIG. 3 shows a basic and schematic illustration of a device 10 for applying a coating to the face of a substrate 1. In conjunction with the schematic illustrations of FIG. 4, a basic process sequence for the production of the substrate 1 with a coating for preventing face plugging is described.

FIG. 3 shows a device 10 with an elastic base 11 onto which a coating of a liquid coating material 12 can be applied by means of an application unit 13.

The elastic base 11 has a closed surface. The closed surface prevents the penetration of the coating material into the material located underneath, and thereby ensures less material loss. In order to guarantee the most uniform possible exertion of pressure, the base 11 is supported by a fixed, non-elastically-deformable base plate 14. The flexible cushion 21 is not shown, which, according to the invention, would be positioned between the elastic base 11 and the base plate 14.

The coating material can be a material with a viscosity such that it can be applied with a layer thickness between preferably 0.2 and 3 mm on a flat surface of the elastic base 11 so that it forms a closed surface.

The coating material 12 can be applied by means of an application unit 13. In particular, the coating material 12 can be applied by placing the coating material on the elastic base 11 and distributing it by means of a doctor blade or an application using a film applicator (as an application unit).

Alternatively, as sketched in FIG. 4, in step S1, the coating material 12 can be applied via a slot die 13 (as an application unit), which moves in a translatory manner relative to the elastic base 11 at a constant distance and thereby releases the liquid coating material 12. The coating material 12 may have a solution containing precious metal which, with the aid of a gelling agent, is increased in viscosity to such an extent that a coherent wet film of constant thickness can be applied to the base 11.

The elastic base 11 moving relative to the slot die can be a conveyor belt so that a very precisely adjustable layer thickness of the coating material 12 can be applied to the entire surface of the moving elastic base 11 via a slot die 13 to thereby ensure, —in particular, in connection with the closed surface—a reproducible and defined material transfer to the substrate.

After the application of the coating material 12, in step S2, the face of the substrate 1 to be coated is pressed into the coating material 12 by means of a pressing-in unit 16—in particular, perpendicularly to the surface direction of the base 11. In so doing, the elastic base 11 deforms due to its elasticity, so that the web-shaped surfaces come into contact with the coating material 12 even in the case of an uneven face. It is thereby possible to wet a complete coating of all surface sections of the face of the substrate 1 that is formed by the web-like walls between the through-channels 2 with the coating material, to thereby reduce or eliminate face plugging over the entire face.

After pressing the substrate 1 into the coating material 12 on the elastic base 11, in step S3, the substrate 1 wetted with the coating material 12 is lifted off the base and can then, if necessary, be fed to a separate thermal treatment to dry or calcine the applied coating material.

Subsequently, in step S4, the coating material 12 is removed from the substrate 11, e.g., with a scraper 15, and it is thereby again prepared for subsequently coating a substrate 1 with a constant wet film thickness.

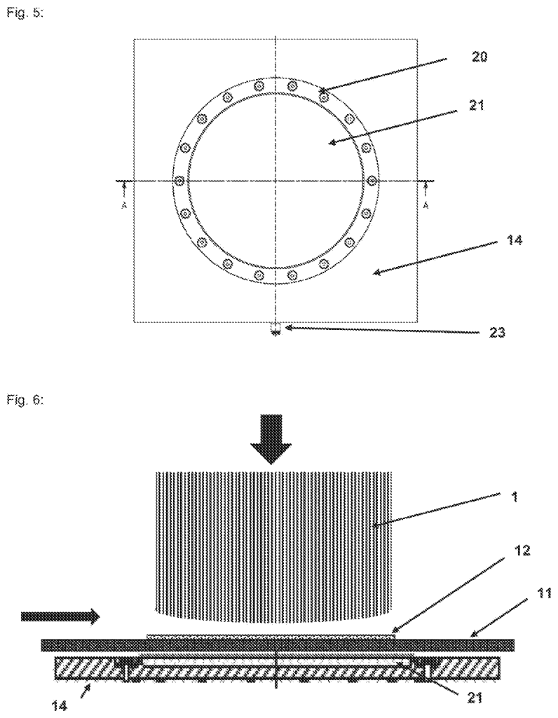

FIG. 5 shows a base plate 14 which has a recess with the flexible cushion 21 located therein. The recess is enclosed by a fastening ring 20. Via an access 23 through the base plate 14, the cushion 21 located in the recess can advantageously be filled with filling material and thereby be adapted to changed circumstances with respect to the substrate quality. According to the invention, the base plate 14 with the cushion 21 replaces the base plate 14 in FIGS. 3 and 4.

FIG. 6 shows the base plate 14 with the recess and the flexible cushion 21 located therein under the elastic base 11. A substrate 1 with a concave face is pressed into the coating material 12. The generated pressure on the elastic material 11 is substantially absorbed by the cushion 21 in the recess of the non-elastic base plate 14. After the substrate 1 is lifted off the elastic base 11, the latter can act as a conveyor belt to place subsequent coating material 12 over the cushion, and a new substrate 1 can accordingly be coated.

### Numbering of the Figures

1: Substrate to be coated
2: Through-channels
3: Intermediate walls
4: Face of the substrate 1
5: Inlet openings of the through-channels 2
6: Intermediate walls
10: Device
11: Elastic base
12: Coating material
13: Application unit
14: Base plate
15: Scraper
16: Pressing-in unit
20: Fastening ring
21: Flexible cushion
23: Connection for filling the flexible cushion

1. Method for producing a substrate (1) for an exhaust gas aftertreatment device, having the following steps:
applying (S1) a coating material (12) on an elastic base (11);
dipping or pressing (S2) a surface of the substrate (1), in which inlet openings of through-channels (2) through the substrate (1) are arranged, into the coating material (12);
lifting (S3) the coated substrate (1); and
aftertreating, and in particular drying or calcining, the coating material (12) on the coated substrate (1),
wherein the elastic base (11) extends over a flexible cushion (21), and said cushion absorbs the pressure of the substrate (1) on the elastic base (11) such that all the inlet openings of through-channels (2) through the substrate (1) can be wet with the coating material (12).

2. Method according to claim 1, wherein the coating material (12) comprises a catalytically-active component, and in particular a precious-metal-containing solution.

3. Method according to claim 1, wherein the surface of the substrate (1) to be coated has a convex or concave or otherwise irregularly-shaped structure with respect to its axial direction.

4. Method according to claim 1, wherein the base (11) is an elastic plastic or a rubber material, and in particular a foam rubber material, and has a smooth and/or closed surface.

5. Method according to claim 1, wherein the liquid coating material (12) is applied to the elastic base (11) in a planar manner, and in particular with a constant layer thickness.

6. Method according to claim 4, wherein the coating material has a layer thickness of 0.2 to 4 mm.

7. Method according to claim 1, wherein the coating material is shear-thinning, so that the application of the coating material does not lead to film breaks, wherein a viscosity of the coating material at 20° C. is selected from 0.5 to 10 Pa*s.

8. Method according to claim 1, wherein the coating material (12) is applied to the base (11) by a doctor blade or by a film drawing device on the base (11) or by a slot die (13) on the base (11) moved relative to the slot die.

9. Method according to claim 1, wherein the residual coating material (12) of a preceding coating operation remaining before the application of the coating material (12) is removed in particular by scraping.

10. Device (10) for manufacturing a substrate (1) for an exhaust aftertreatment device, comprising:
an in particular horizontally-oriented elastic base (11) with a closed surface;
an application unit (13) which is configured to apply a liquid coating material (12) to the base (11);
a pressing-in unit (16) which is designed to dip or press a substrate (1) to be coated into the coating material (12) after the coating material (12) has been applied, wherein the elastic base (11) extends over a flexible cushion (21), and this cushion absorbs the pressure of the substrate (1) on the elastic base (11) in such a way that all the inlet openings of through-channels (2) through the substrate (1) can be wet with the coating material (12).

11. Device according to claim 9, wherein a non-elastically-deformable base plate (14) is arranged below the elastic base (11) and the cushion (21).

12. Substrate (1) produced according to the method according to claim 1.
